(19) United States
(12) Patent Application Publication
(10) Pub. No.: US 2018/0194063 A1
(43) Pub. Date: Jul. 12, 2018

(54) BUILD MATERIAL CONTAINERS

(71) Applicants: Juan Manuel Zamorano, Sant Cugat del Valles (ES); Marina Ferran Farres, Sant Cugat del Valles (ES); Sergio De Santiago Dominguez, Sant Cugat del Valles (ES); HEWLETT-PACKARD DEVELOPMENT COMPANY, L.P., Houston, TX (US)

(72) Inventors: Juan Manuel Zamorano, Barcelona (ES); Marina Ferran Farres, Barcelona (ES); Sergio De Santiago Dominguez, Barcelona (ES)

(73) Assignee: HEWLETT-PACKARD DEVELOPMENT COMPANY, L.P., Houston, TX (US)

(21) Appl. No.: 15/567,515

(22) PCT Filed: Sep. 30, 2015
(86) PCT No.: PCT/EP2015/072590

§ 371 Date: Oct. 18, 2017

(51) Int. Cl. B29C 64/255; B33Y 30/00; B22F 3/00; B29C 64/245; B33Y 40/00; B29C 64/321

(52) U.S. Cl. CPC B29C 64/255; B33Y 30/00; B29C 64/321; B29C 64/245; B33Y 40/00; B22F 3/003

(57) ABSTRACT

A build material container (100) may comprise a container body (102) enclosing a volume to contain a build material (104) for three-dimensional printing. In an example, the container body comprises a sidewall. A compressible wall element (108) may be disposed in the sidewall, wherein compression of the compressible portion wall element reduces the volume of the container. An opening (112) to introduce the build material into the container body may be disposed in an upper region of the sidewall.

### BACKGROUND

Three-dimensional objects generated by an additive manufacturing process may be formed in a layer-by-layer manner. In one example of additive manufacturing, an object is generated by solidifying portions of layers of build material in an apparatus. The build material may be in the form of a powder, fluid or sheet material. The powder and fluid build material may be held in a container prior to use in the manufacturing process.

### BRIEF DESCRIPTION OF DRAWINGS

For a more complete understanding, various examples will now be described below with reference to the accompanying drawings in which:

FIG. 1 is a block diagram of an example of a build material container in a first configuration;

FIG. 2 is a block diagram of an example of the build material container of FIG. 1 in a second configuration;

FIG. 3 is a block diagram of another example of a build material container;

FIGS. 4 and 5 are block diagrams of examples of an object generation apparatus comprising a build material container; and

FIG. 6 is an example illustration of a process which may be employed according to the present disclosure.

### DETAILED DESCRIPTION

Some examples described herein provide a container to contain a build material for use in printing a three-dimensional object. The container may be used in an apparatus such as a three-dimensional object generation apparatus.

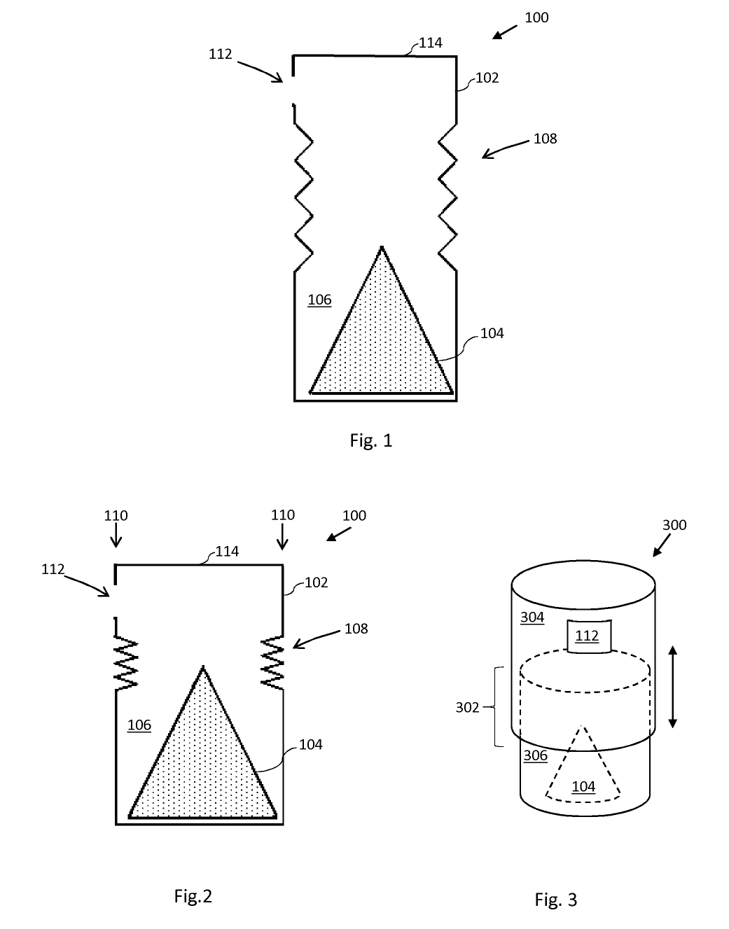

Examples of the present disclosure are described with reference to FIGS. 1 to 6. It should be noted that the description and figures merely illustrate principles of the present disclosure. It is thus understood that various arrangements may be devised that, although not explicitly described or shown herein, embody the principles of the present disclosure. Moreover, all statements herein reciting principles and examples of the present disclosure, as well as specific examples thereof, are intended to encompass equivalents thereof. Throughout the figures, like reference numerals denote like parts.

FIGS. 1 and 2 illustrate an example of a build material container 100. The container 100 comprises a container body 102 to contain a build material 104 for three-dimensional printing. The build material 104 may be held in a hollow volume 106 of the container body 102. In one example, the material 104 for three-dimensional printing to be contained in the container body 102 is a powder-like build material. For example, the build material 104 may be a plastic in powder format (for example, a Polyamide PA11, a Polyamide PA12, etc.), a metallic powder, etc.

The container body 102 may be of any shape. For example, the container body 102 may be a cylinder, a cube, a cuboid, a triangular prism, a pentagonal prism, a hexagonal prism, an octagonal prism, etc. In an example, the container body 102 may be tapered along its length, i.e. the cross-sectional area of the container body 102 may decrease along its length. In other examples, the container body 102 may have a consistent cross-sectional area along its length. The container body 102 may be symmetrically shaped about its axial length or the container body 102 may be asymmetrical shaped about its axial length.

The container body 102 comprises a compressible wall element 108. In this example, the compressible wall element 108 extends around a lateral perimeter of the container body 102. The compressible wall element 108 may be symmetrical about an axial length of the container body 102 or asymmetrical about an axial length of the container body 102. The compressible wall element 108 is a reconfigurable, or deformable, portion of the container body 102.

The compressible wall element 108 in this example is deformable in such a way that may allow the internal volume 106 of the container 100 to be altered or adjusted. The compressible wall element 108 may be deformable under an applied force 110 to change or alter a height or volume of the container 100 (as shown in FIG. 2). The compressible wall element 108 may be deformable upon application of a force 110 to a top surface 114 of the container body 102. In some examples, the force 110 may be applied to the top surface 114 of the container body 102 in a direction that is substantially orthogonal to the top surface 114 of the container body 102. By compressing (or deforming) the compressible wall element 108, the volume (or height) of the container 100 may be reduced. Similarly, by decompressing the compressible wall element 108 (for example, by releasing the applied force, or by applying an expansion force), the volume (and, in this example, the height) of the container 100 may be increased.

The compressible wall element 108 may have properties (such as elastic properties) that enable it to return to its original shape and/or dimensions when an applied force 110 is released. In other words, the container 100 may be able to recover or at least partially recover its original height (or volume) after an applied force 110 is removed. In other examples, it may be restored to its original size, for example using a mechanism, which may, in some examples, be the same mechanism used to apply the compressive force. An example of such a mechanism is described in relation to FIG. 5 below.

The container body 102 also comprises an opening 112, which in an example is lateral opening 112. The opening 112 is for use in introducing or reintroducing build material 104 into the container body 102, and is provided in an upper region of the container body 102, i.e., the opening 112 is in a region of a sidewall of the container body 102 which is, in use of the container, intended to be above any build material 104 contained therein. Build material 104 may be introduced or reintroduced into the container 102 manually or automatically. The opening 112 may enable access to the contents of the container 100 before, during and/or after a print operation (or process). As in this example the opening 112 is in an upper region of the container body 102, and is above the build material 104, access remains possible when the compressible wall element 108 is partially or fully compressed, or during compression thereof. For example, the opening 112 is for use in filling or refilling the container body 102 before, during and/or after a print operation. Further, the lateral opening 112 may be used to remove or manage build material 104 within the container 100 (for example, a powder build material may become compacted and unusable without intervention).

In the example of FIG. 1, the lateral opening 112 is positioned above the compressible wall element 108. However, the lateral opening 112 may be formed in the compressible wall element 108 (for example in an upper region thereof) in other examples. The lateral opening 112 may be an opening in an upper region of a sidewall of the container body 102, for example in a relatively stiff region thereof. The lateral opening 112 may extend around at least part of the lateral perimeter of the container body 102. The size and/or shape of the lateral opening 112 may depend on the material 104 to be introduced into the container 100. In some examples, the size and/or shape of the lateral opening 112 is adjustable.

In the example of FIG. 1, the compressible wall element 108 comprises a bellows-like construction, which may be formed of a relatively rigid material with hinges between sections thereof or formed therein. For example, the container 100 may be formed from a molded plastic, which may be formed with integral hinges, for example provided by relatively thin sidewall sections extending around the perimeter of the container body 102 in the compressible wall element 106. In other examples, the compressible wall element 108 may be made of a compressible (or deformable or malleable) material such as a soft plastic, an elastomer, silicone, etc., or a flexible material which may collapse when an expanding force is removed. In some examples, the compressible wall element 108 is resilient, such that it returns to an uncompressed state when a compressive force is removed. More than one compressible wall element 108 may be provided, for example separated by non-compressible wall elements (i.e. portions of the sidewall which do not readily reconfigure or deform during use of the apparatus).

FIG. 3 shows another example of a container 300, in which sidewall is formed of two sidewall portions, the container 300 comprises a compressible wall element 302 provided by a telescoping arrangement in which a first rigid portion 304 slides over a second rigid portion 306, providing an overlapping telescopic portion. The length of the sidewall is changed by changing the overlap between the rigid portions 304, 306.

A container 100, 300 may be for use in a three-dimensional object generation apparatus.

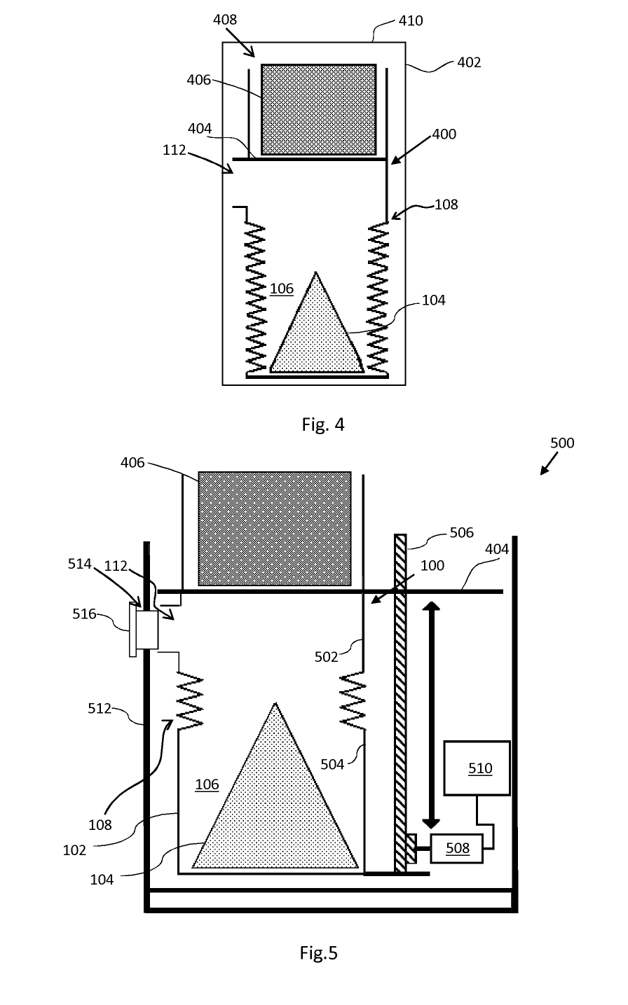

FIG. 4 illustrates a container 400 in a three-dimensional object generation apparatus 402. In this example, the container 400 comprises a compressible bellows section which extends substantially the length of the container 400 between the lateral opening 112 and a base of the container 400.

The container 400 may be inserted into and removed from the three-dimensional object generation apparatus 402. In other words, the container 400 may be a removable and/or a reusable container. The container 400 may be filled or at least partially filled with material for three-dimensional printing prior to being inserted into the object generation apparatus 402 and/or while it is in place in the object generation apparatus 402.

The three-dimensional object generation apparatus 402 comprises a moveable platform 404. The moveable platform 404 in this example comprises a print bed, on which a three-dimensional object 406 may be formed, within a volume 408 provided between the platform 404 and a top surface 410 of the apparatus 402. As the build material 104 is used to generate the object, the volume of build material 104 in the container 400 (and the volume to store it) reduces, allowing the platform 404 to move downwards. These processes are therefore complimentary: as the object 406 grows in size, build material 104 is consumed, the container 400 may reduce in volume, increasing the volume 408 for the object 406 as the print bed provided in this example by the moveable platform 404 moves downwards and away from the top surface 410 (for example a lid of the apparatus 402). Such an apparatus 402 may be relatively compact.

In FIG. 4, movement of the moveable platform 404 of the three-dimensional object generation apparatus 402 towards the container 400 causes the height (or volume) of the container 400 to reduce, i.e. the top of the container 400 and the moveable platform 404 are coupled (or formed integrally such that the moveable platform 404 provides the print bed and the top of the container 400), such that the movement of the platform 404 provides a force on the compressible wall element 108. The opening 112 moves with the moveable platform 404 (i.e. the lateral opening 112 may remain open as the moveable platform 404 moves). The container 400 can be at least partially refilled during the printing process, while the container 400 is in place in the object generation apparatus 402.

FIG. 5 shows another example of a three-dimensional object generation apparatus 500. In this example, the container 100 is similar to that described in relation to FIG. 1. More particularly, the container 100 in this example comprises three portions: an upper portion 502 comprises the powder container opening, a central portion is a compressible wall element 108 and a base portion 504. In this example, the base portion 504 encloses a volume in which build material 104 may be housed, but in other examples may comprise a substantially planar base on which the compressible wall element 108 is mounted, with the compressible wall element 108 providing the volume 106 to hold the build material, as shown in FIG. 4.

The upper portion 502 and/or the base portion 504 in this example are non-compressible wall elements, and are made of a rigid material, for example a hard plastic, a metal, or the like. Portions 502 and 504 may hold or substantially hold their shape under an applied force. In other words, portions 502 and 504 may not (or substantially not) compress (or reconfigure, or deform) under an applied force. Therefore, the container 100 may not completely deform or lose its original shape under an applied force. Instead, the container 100 will substantially maintain its original shape. The size or volume of the container 100 can be altered under an applied force, whilst a hollow volume 106 within the container body 102 for holding the material 104 can be maintained. As the opening 112 is formed in the rigid upper wall element, the opening 112 can remain open when the compressible wall element 108 is compressed.

The container 100 is positioned underneath the moveable platform 404 of the three-dimensional object generation apparatus 500. In other words, the moveable platform 404 (for example, a bottom surface of the moveable platform 404) of the three-dimensional object generation apparatus 500 may be coupled to, or provide a top surface of, the container body 102.

In FIG. 5, the moveable platform 404 is mounted on a drive screw 506. The drive screw 506 is turned by a motor 508, which in turn is controlled by a controller 510. Turning the screw 506 raises or lowers the platform 404. Lowering the platform 404 exerts a compressive force on the container 100, whereas raising the platform 404 applies an expansion force, causing the volume of the container 100 to increase. Thus, a force is transferred from the moveable platform 402 to the container 100, causing the compressible wall element 108 of the container body 102 to deform (compress or expand) such that the height (or volume) of the container 100 is changed.

The apparatus 500 further comprises a housing 512, having an opening 514 in the region of the container opening 112, which in the Figure is sealed with a stopper 516, and through which material may be introduced into the container 100.

The controller 510 may control the rate of movement of the platform for example according to predetermined data or in response to user input.

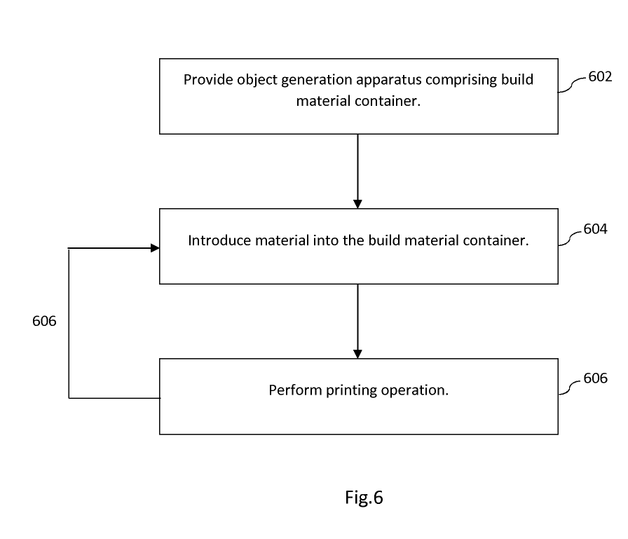

FIG. 6 is a flowchart in which, at block 600, an apparatus such as a three-dimensional object generation apparatus, which may be a three-dimensional object generation apparatus 402, 500 as described above, is provided. Such object generation apparatus comprises a container, which may be a container 100, 300, 400 as described above. The container may be empty or may be filled or at least partially filled with a material for three-dimensional printing.

At block 602, a material for three-dimensional printing is introduced into the container of the object generation apparatus. In other words, the container is filled (or at least partially filled) or refilled (or at least partially refilled) with a material for three-dimensional printing.

At block 604, a printing operation (or process) may be performed by the object generation apparatus. The printing operation may cause the object generation apparatus to produce (or print) a three-dimensional object.

It will be understood that block 602 may be performed prior to a printing operation of the object generation apparatus (as shown) and/or during a printing operation of the object generation apparatus (as shown by feedback arrow 606) and/or after a print operation of the object generation apparatus (not shown). In some examples, refilling occurs following deformation of the deformable portion to reduce the volume of the container (wherein such deformation comprises any reconfiguration from a starting configuration).

Although the flow diagram described above show a specific order of execution, the order of execution may differ from that which is depicted.

While the method, apparatus and related aspects have been described with reference to certain examples, various modifications, changes, omissions, and substitutions can be made without departing from the spirit and scope of the present disclosure. It should be noted that the above-mentioned examples illustrate rather than limit what is described herein, and that those skilled in the art will be able to design many alternative implementations without departing from the scope of the appended claims. For example, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A build material container comprising:
a container body enclosing a volume to contain a build material for three-dimensional printing,
the container body comprising:
a sidewall;
a compressible wall element disposed in the sidewall, wherein compression of the compressible wall element reduces the volume of the container, and
an opening disposed in a region of the sidewall to introduce the build material into the container body, wherein the opening is in an upper region of the sidewall.

2. The build material container according to claim 1, wherein a non-compressible wall element is disposed within the sidewall and coupled to the compressible wall element and the opening is disposed in the non-compressible wall element.

3. The build material container according to claim 1, wherein the compressible wall element is compressible upon application of a force to a top surface of the container body.

4. The build material container according to claim 3, wherein the force is applied in a direction that is substantially orthogonal to the top surface of the container body.

5. The build material container according to claim 1, wherein the compression of the compressible wall element reduces a height of the build material container.

6. The build material container according to claim 1, wherein the compressible wall element comprises at least one of a bellows section, a telescopic section or a compressible material.

7. The build material container according to claim 1 in which the opening is disposed above the compressible wall element.

8. The build material container according to claim 1, wherein a surface of the container comprises a moveable platform, the moveable platform comprising a three dimensional object generation print bed.

9. An object generation apparatus comprising:
a print bed on which an object is formed from the build material; and
a build material container to contain build material comprising a sidewall, the sidewall having disposed therein:
a compressible wall element, wherein compression of the compressible wall element reduces the volume of the container, and
an opening to receive build material, wherein the opening is disposed in an upper region of the sidewall.

10. The object generation apparatus according to claim 9 wherein the print bed is coupled to a moveable platform, wherein movement of the moveable platform causes a change in the length of the compressible wall element.

11. The object generation apparatus according to claim 10 in which the movable platform is coupled to the build material container.

12. The object generation apparatus according to claim 10, further comprising a volume in which an object is formed and wherein a movement of the moveable platform to reduce the volume of the build material container increases the volume in which an object is formed.

13. A method comprising:
providing a build material container enclosing a volume to contain a build material for three-dimensional printing, the build material container comprising an opening to receive build material and a deformable portion, wherein deformation of the deformable portion changes the volume of the build material container; and
at least partially filling or at least partially refilling the build material container with a material for three-dimensional printing following deformation of the deformable portion to reduce the volume of the container.

14. The method according to claim 13, wherein at least partially filling or at least partially refilling the build material container with a material for three-dimensional printing method is performed during a printing operation.

15. The method according to claim 13, further comprising:
providing a moveable platform on which an object generated by the three-dimensional printing is formed, and
moving the moveable platform during a print operation to increase a volume in which the object is formed and to decrease the volume of the build material container as build material is consumed in the generation of the object.
